(19) United States
(12) Patent Application Publication
(10) Pub. No.: US 2011/0038057 A1
(43) Pub. Date: Feb. 17, 2011

(54) Optical Imaging Lens Systems

(76) Inventors: Saman Dharmatilleke, Singapore (SG); Medha Dharmatilleke, Singapore (SG)

Correspondence Address: Namal C. Warshakoon, 2909 Oakton Crest Place, Vienna, VA, 22181, US

(21) Appl. No.: 12/989,419

(22) PCT Filed: Apr. 23, 2009
(86) PCT No.: PCT/SG09/00151

§ 371 Date: Oct. 24, 2010

(30) Foreign Application Priority Data
Apr. 23, 2008 (SG) PCT/SG2208/000136

(51) Int. Cl. G02B 15/00; G02B 3/00; B29D 11/00

(52) U.S. Cl. 359/694; 359/796; 264/2.7

(57) ABSTRACT

Optical imaging lens systems are disclosed in which a lens assembly (110) is operable to simultaneously focus light rays originating from various distances onto a first focal plane which is maintained at a fixed distance from the lens assembly (110). To this purpose, the lens assembly (110) may have at least one non-uniform optical property.

### BACKGROUND

1. Technical Field

Embodiments of the invention relate to optical imaging lens systems and mounting arrangements thereof, and methods of fabricating.

2. Description of Related Art

A common type of variable focus system involves multiple solid lenses in which relative distances between two or more lenses can be varied to alter the focal length of the lens system. A drawback of this system is the relatively large form factor which limits the size of a device incorporating the variable focus system.

With increasing demand for miniaturized devices, an optical system having smaller form factor and improved performance is desired.

### SUMMARY OF EMBODIMENTS OF THE INVENTION

Embodiments of the invention relate to optical imaging lens systems having a lens assembly configured to simultaneously focus light rays originating from objects disposed at various distances onto a first focal plane which is maintained at a fixed distance from the lens assembly. The objects may be disposed at a near distance or at near-infinity distance from the lens assembly. To this purpose, the lens assembly has at least one non-uniform optical property.

Various arrangements may be envisaged to achieve the at least one non-uniform optical property in the lens assembly. In one embodiment, at least one of the lenses may have at least one graded optical property, i.e. graded lens. In another embodiment where at least some of the lenses have a susbtantially uniform optical property within each lens, i.e., non-graded lens, at least two of the lenses may have at least one different optical property. In certain embodiments, at least some of the lenses may be disposed in different directions.

In certain embodiments, a retainer structure may be provided to support the lenses. In certain applications, a suitable actuator, e.g. piezo actuator, may be employed in cooperation with embodiments of the invention to perform a zoom or focus function.

Embodiments of the invention are particularly advantageous in providing an optical imaging lens system which is capable of simultaneously focusing light rays originating from objects disposed at various distances onto a first focal plane which is maintained at a fixed distance from the lens assembly. Hence, embodiments of the invention enable imaging devices in small and compact form factor while still providing quality focus and, in some applications, zooming functions.

### BRIEF DESCRIPTION OF THE DRAWINGS

FIG. 1A illustrates an optical system having a lens assembly which includes two lenses according to one embodiment of the invention.

FIG. 1B illustrates the embodiment of FIG. 1A in cooperation with an image sensor provided at an image plane.

FIG. 2 illustrates an optical system having a lens assembly which includes more than two lenses according to one embodiment of the invention.

FIG. 3 illustrates an optical system having a lens assembly which includes multiple lenses in which at least some of the lenses are arranged in different directions.

FIG. 4 illustrates an optical system having a lens assembly which includes minute defects formed in a lens.

FIG. 5 illustrates an optical system having a lens assembly in which one of the lenses is integrally formed with a retainer structure.

FIG. 6 illustrates an optical system, having a lens assembly in which one of the lenses is integrally formed with a retainer structure, in a deployment position.

FIG. 7A is a side cross-sectional view of a piezo actuator.

FIG. 7B is a top or bottom view of the piezo actuator of FIG. 7A.

FIG. 7C illustrates an exemplary profile of an output voltage pattern produced by a control circuit.

FIGS. 8A and 8B illustrate piezo actuators employed in cooperation with the embodiments of FIG. 1A and FIG. 3 respectively.

FIGS. 9A to 9C illustrate examples of an optical system suitable for use as an eye implant or prescription glasses.

### DETAILED DESCRIPTION OF ILLUSTRATIVE EMBODIMENTS

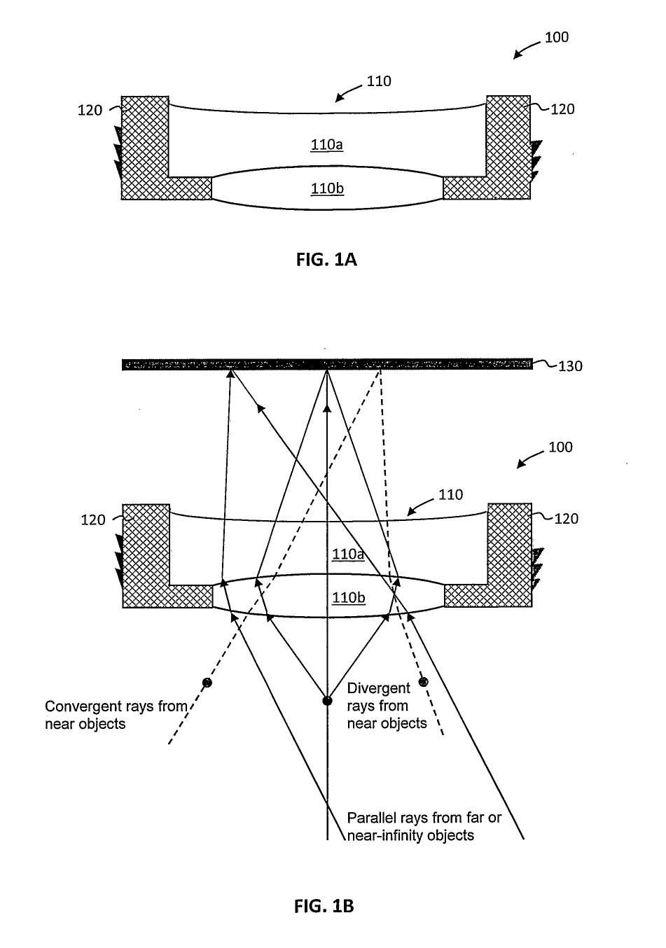

In the following description, numerous specific details are set forth in order to provide a thorough understanding of various illustrative embodiments of the present invention. It will be understood, however, to one skilled in the art, that embodiments of the present invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views. It is to be appreciated that FIGS. 1A-1B, 2-6, 8A-8B and 9A-9C are cross-sectional views taken from a plane parallel to an optical axis of the respective optical system.

Embodiments of the invention such as, but not limited to, those illustrated in FIGS. 1A-1B, 2-6, 8A-8B, 9A-9C, include a lens assembly which includes multiple lenses disposed in a juxtaposed arrangement. The lenses may be transparent substrates and include a material such as, but not limited to, glass, epoxy, polymer, monomer, plastic, a suitable optical material, an optically active material or a combination thereof. Each of the materials forming the lenses may be deformable or non-deformable, elastic or elastomeric, compressible or/non-compressible, or inelastic or fixed. At least one of the lenses may be in a solid state or soft form or soft state or liquid state or flowable state or flowable form in a final product. During fabrication of the lens assembly, the lenses may be provided in a gaseous, solid, or liquid state, or in a soft form. Various methods that may be employed to provide a juxtaposed arrangement of multiple lenses include, but are not limited to, coupling separate lens substrate layers, growing the lens substrate layers from a single lens subtrate.

The lens assembly of the optical system is operable to simultaneously focus light rays originating from various distances onto a first focal plane. More particularly, parallel, convergent or divergent light rays from objects at near distances (e.g. at least a few millimetres), and parallel or near parallel light rays from far objects or objects at near-infinity distances may be simultaneously focused onto a first focal plane while maintaining quality focus of a formed image with an acceptable tolerance limit. In certain embodiments, a separation distance between a second focal plane where an image of a near object may be formed and a third focal plane where an image of a far object may be formed should have an acceptable tolerance limit, e.g., at most about ±300 micrometres, at least about ±300 micrometres. The first focal plane may be suitably maintained at a fixed distance from the lens assembly whether the optical system is focussing on objects at near distances, or objects at near-infinity distances, or both. Thus, when focussing objects at various distances, the optical sytem does not require varying a relative distance between the lens assembly and a first focal plane or an image plane on which images of the objects are focussed on to be captured by an image sensor. In other words, the first focal plane for forming capturing images disposed at various distances, including near distances and near-infinity distance, is fixed relative to the lens assembly. Since a relative movement between lenses is not necessary when performing a focus function, the optical system would require less space and less power. The image plane may be provided as part of an image sensor, such as but not limited to, a charge-coupled device (CCD), a complementary metal-oxide-semiconductor (CMOS) active-pixel sensor and a photographic film.

Simultaneous focussing of objects at near distances and objects at near-infinity distances without varying a relative distance of the first focal plane and the lens assembly may be achieved by having at least one non-uniform optical property within the lens assembly. Various arrangements may be employed for this purpose, some of which are described as follows. In one embodiment, at least one of the lenses may have at least one graded optical property (also referred to as a graded lens) in which at least one optical property varies gradually or abruptly within the lens according to a predetermined or non-predetermined profile. Grading may be achieved by controlling the impurity content of the lens material, or by controlling the temperature profile or growth environment profile during the lens fabrication process. In another embodiment where at least some of the lenses have susbtantially uniform optical property within each lens (also referred to as a non-graded lens), at least two of the lenses may have at least one different optical property. In yet another embodiment, the lens assembly may include both graded and non-graded lenses. In certain embodiments, at least two of the lenses may be arranged in different directions. The above-described arrangements of achieving at least one non-uniform optical property in a lens assembly, and other arrangements not described, generally apply to embodiments of the invention and hence will not be further reproduced in the following paragraphs relating to each embodiment.

In the present disclosure, the term “optical property” includes, but are not limited to, refractive index, light transmission coefficient, absorption coefficient, dispersion power, polarization, stretchability, Abbe number, focal length, optical power, reflective performance, refractive performance, spot size, resolution, modulation transfer function (MTF), distortion, and diffractive performance.

According to some embodiments of the invention, a retainer structure may be provided to support the lenses. In certain other embodiments, a retainer structure may not be required. Depending on the intended application of the optical system, the retainer structure may include a heat-resistant material such as, but not limited to, a liquid crystal plastic, a black liquid crystal plastic, an epoxy, a polymer and a monomer. The liquid crystal plastic may include glass fibers or frits. If required, the retainer structure may include threads to facilitate installation or mounting of the optical system to an external body or device. The retainer structure may be formed of a transparent or a non-transparent (opaque) material. If heat-resistant materials are used, the optical system may be employed in a high-temperature environment, e.g. a reflow oven.

FIG. 1A illustrates an optical system according to one embodiment of the invention. The optical system 100 incudes a lens assembly 110 which includes a first lens 110a and a second lens 110b juxtaposed to the first lens 110a. A retainer structure 120 as illustrated, but not limited as such, may be provided to support the lenses 110a, 110b. Threads may be provided on the retainer structure 120 to facilitate installation or mounting of the optical system 100 to an external body or device.

FIG. 1B illustrates the embodiment of FIG. 1A in cooperation with an image plane provided in an imaging device. As illustrated in FIG. 1B, parallel, convergent or divergent light rays from near objects, and parallel or near parallel light rays from objects at near-infinity distances may be simultaneously focused onto a first focal plane or image plane 130 which may be maintained at a fixed distance from the lens assembly 110.

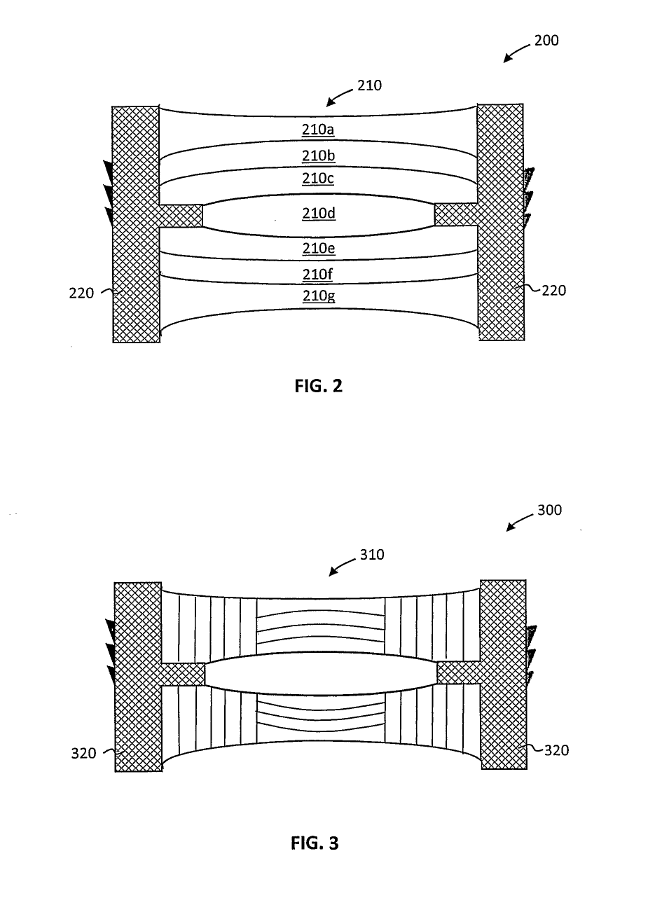

FIG. 2 illustrates an optical system 200 having a lens assembly 210 which includes multiple lenses 210a, 210b, 210c, 210d, 210e, 210f, 210g. Threads may be provided on the retainer structure 220 to facilitate installation or mounting of the optical system 200 to an external body or device. While FIG. 2 illustrates a lens assembly being formed of seven lenses, it is to be appreciated that other number of lenses, i.e., at least two, in the lens assembly may be envisaged in other embodiments of the invention.

FIG. 3 illustrates an optical system 300 having a lens assembly 310 which includes multiple lenses in which at least some of the lenses are arranged in different directions. Threads may be provided on the retainer structure 320 to facilitate installation or mounting of the optical system 300 to an external body or device. While FIG. 3 illustrates a lens assembly being formed of multiple lenses arranged in certain directions, other directions and combinations of directions may be envisaged in other embodiments of the invention.

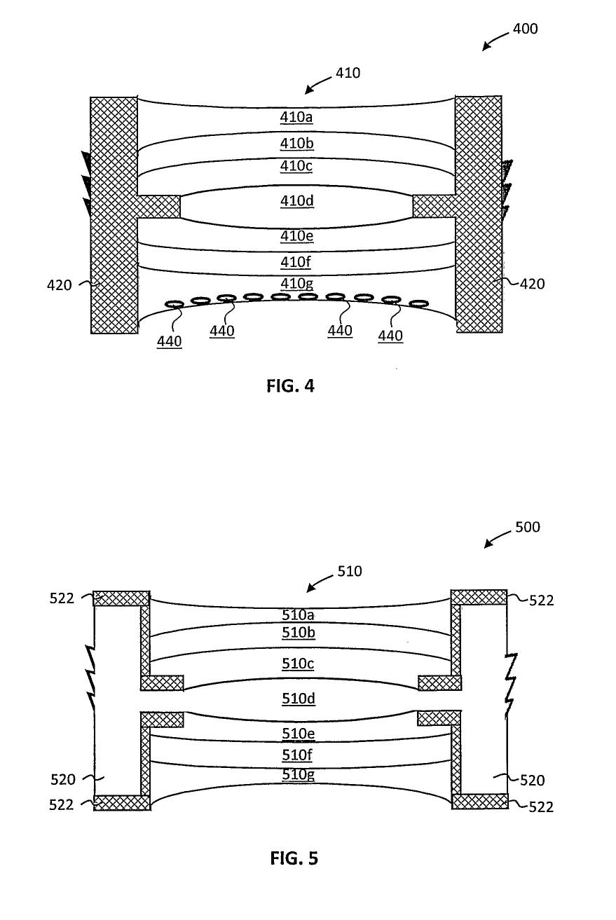

FIG. 4 illustrates an optical system 400 having a lens assembly 410 in which at least one of the lenses 410a, 410b, 410c, 410d, 410e, 410f, 410g, includes a plurality of minute defects 440 formed in at least one of the lenses 410a-410g. Alternatively, the defects may be formed at an interface between adjacent lenses. Examples of suitable minute defects include, but are not limited to, pits, impurities, and surface undulations. The lens assembly 410 is operable to increase or maximise a contrast of an image formed between the defects 440 to perform an automatic-focus function.

FIG. 5 illustrates an optical system 500 having a lens assembly 510 in which one or an intermediate one of the lenses 510a, 510b, 510c, 510d, 510e, 510f, 510g is integrally formed with a retainer structure 520. In this example, the retainer structure 520 may include a transparent material. An optically opaque material 522 such as, but not limited to, paint and overmold, may be applied to at least a portion of the retainer structure 520 to block light rays from certain directions from entering the lens assembly 510.

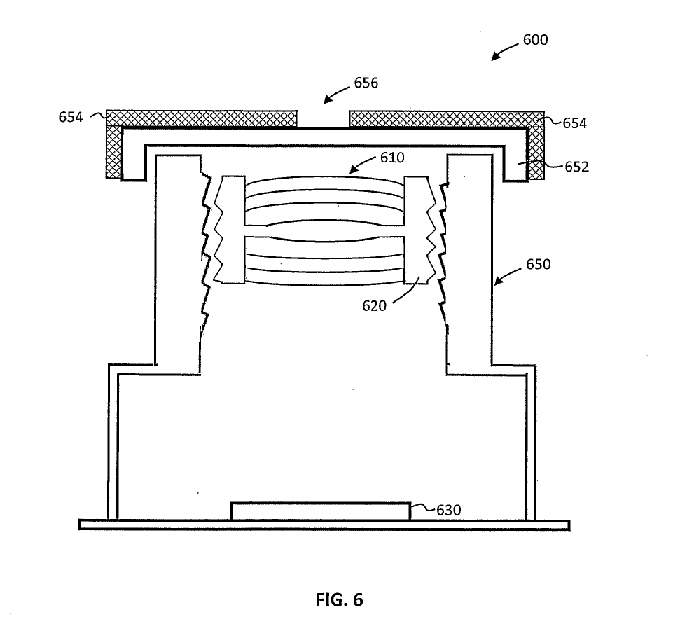

FIG. 6 illustrates an optical system 600 having a lens assembly 610 in which one or an intermediate one of the lenses is integrally formed with a retainer structure 620. In this example, the retainer structure 620 may include an opaque or transparent material. The optical system 600 may be mounted or coupled to an external device 650 using threading or other suitable means. A transparent cover 652 may be disposed near one end of the lens assembly 610 to receive light rays into the lens assembly 610. An optically opaque material 654, such as but not limited to paint and overmold, may be applied to at least a portion of the cover 652 to define an aperture 656 through which light rays may enter the lens assembly 610. An image plane 630 may be provided at an appropriate distance from the lens assembly 610 or at the first focal plane of the lens assembly 610 to capture a focussed image.

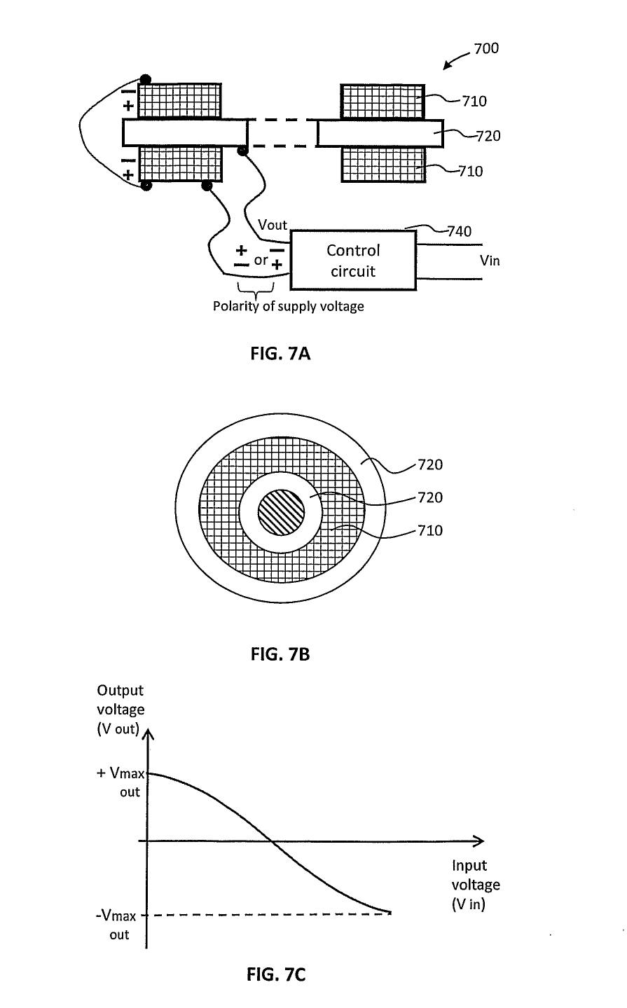

The embodiments of FIGS. 1A-1B, 2 to 6 may be used in cooperation with at least one piezo actuator to achieve a zoom and/or focus function. FIG. 7A is a side cross-sectional view of a piezo actuator 700 which may include a piezo material 710 disposed on and coupled to each of opposed surfaces of an actuating substrate 720 (e.g. metal, polymer, non-metal and semiconductor material) which may be coupled to an outermost layer or an intermediate layer of a lens assmbly. The piezo materials 710 disposed on opposed surfaces of the actuating substrate 720 may be suitably pre-polarized such that the piezo materials 710 have opposite polarities, in order to achieve maximum deflection of the actuating substrate 720 when a voltage is applied to the piezo actuator 700 via a control circuit 740. FIG. 7B is a top or bottom view of the piezo actuator 700 of FIG. 7A. In FIG. 7B, the actuating substrate 720 has an opening to define an aperture leading to the lens assembly disposed therein. The piezo materials 710 and aperture may be provided in an elliptical, circular, rectangular, or any other suitable shapes.

The piezo materials 710 coupled to opposed surfaces of an actuating substrate 720 may be electrically connected to an appropriate control circuit 740 to provide a deflection on the actuator substrate 720 or a compressive and/or decompressive force when the actuator 700 is activated. FIG. 7C illustrates an exemplary profile of an output voltage pattern produced by the control circuit 740. The output voltage pattern is an alternating or switching relationshipto the an input voltage which has a fixed polarity. More particularly, the control circuit is configured to produce an alternating-polarity variable output in response to a fixed-polarity variable input. It is to be appreciated that the output may be provided as a straight line, a curve, a sine wave, a square wave, a triangular wave, a pulsating wave, or any other waveform or pattern that exhibits a change in polarity.

The input voltage to control circuit 740 may be received from an image sensor or autofocus driver circuit. The output voltage from the control circuit 740 may be applied to the piezo materials (piezo actuator) in order to deform the actuator body to generate a compressive or decompressive force which is applied to the lens. When the piezo actuator 700 is activated, the piezo actuator 700 applies a compressive or decompressive force to the lens or substrate layer connected thereto to vary at least one of an optical property of the lens, and a physical property of the lens. As a result of varying at least one of a physical property and an optical property, the lenses may deform or may not deform. In the present description, the term “physical property” includes, but are not limited to, mass, shape, volume, density, thermal property, magnetic property, hardness, energy conversion factor, length, width, and radius of curvature.

Depending on the material used, the lenses of the lens assembly may be deformable or non-deformable, and/or compressible or non-compressible by the operation of the piezo actuator 700. More particularly, lenses which are deformable by the piezo actuator may be compressible or non-compressible; lenses which are non-deformable by the piezo actuator may be compressible or non-compressible. Thus, by using one or more piezo actuators, the optical system is operable to perform a zoom function. In the present description, while a piezo actuator is used to enable focus and/or zoom function in the optical system, it is to be appreciated that other types of actuators including, but not limited to, a voice coil motor, an electromagnet actuator, a thermal actuator, a bi-metal actuator, and an electrowetting device may be used with suitable modifications.

While the above paragraphs and FIG. 7C describe the input and output of the control circuit 740 as a voltage signal. It is to be understood that the input and output of the control circuit 740 may be a current signal with suitable modifications.

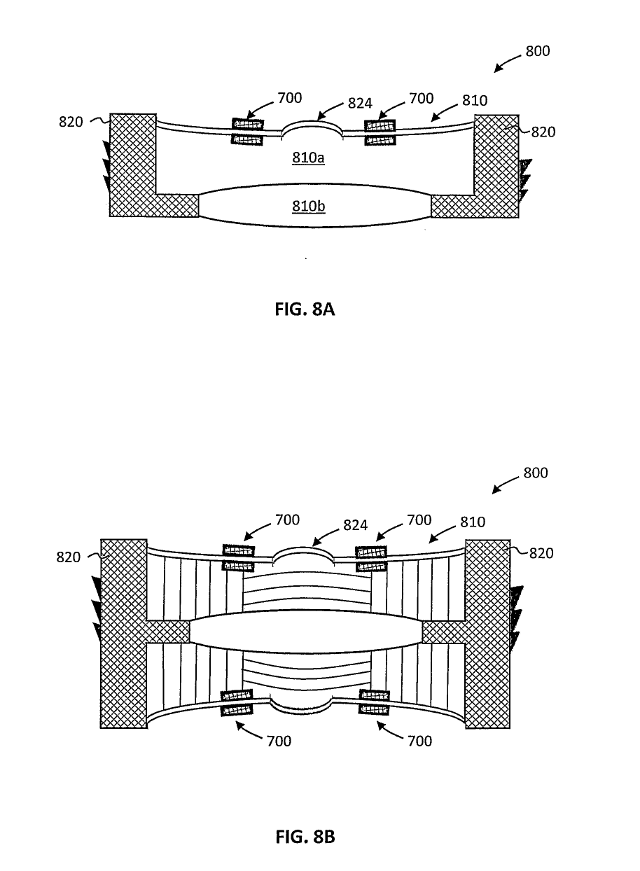

FIG. 8A illustrates a piezo actuator 700 employed in cooperation with the embodiment of FIG. 1A. FIG. 8B illustrates two piezo actuators 700 employed in cooperation with the embodiment of FIG. 3. Similarly, a piezo actuator 700 may be employed with the embodiment of FIG. 2. When a piezo actuator 700 is activated, the piezo actuator 700 applies a compressive or decompressive force to the lens(es) connected thereto to vary at least one optical property of the lens assembly by deforming the lens(es) or by varying a physical property of the lens(es). A stretchable material 824 may be provided to accommodate any deformation in the lens assembly. While the examples of FIGS. 8A and 8B employ two piezo actuators, it is to be appreciated that one piezo actuator may be employed. Also, other arrangements or combinations of the piezo actuators relative to the lens or substrate layers may be envisaged with suitable modifications.

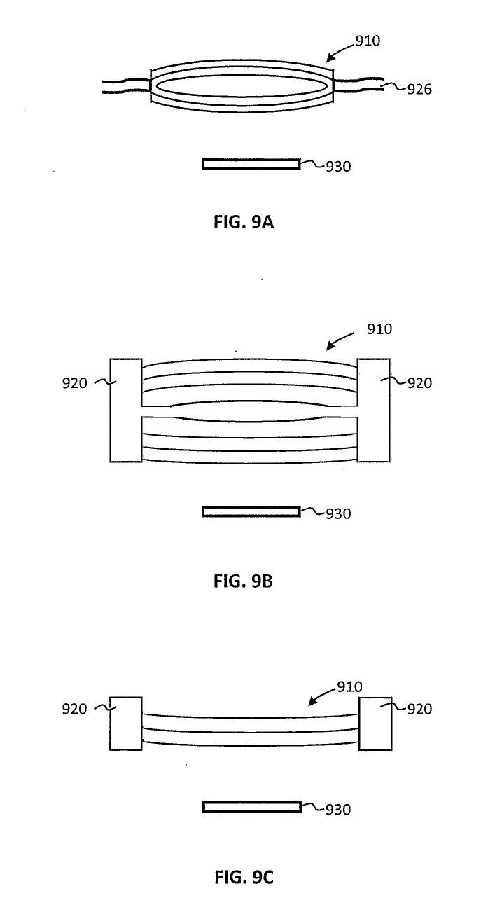

FIGS. 9A to 9C illustrate examples of an optical system suitable for use as an implant in a human eye so that spectacles or prescription glasses would not be required. In certain embodiments, the lens configuration of FIGS. 9A to 9C may be used in spectacles or prescription glasses to enable near view and far view without requiring bi-focal lenses.

FIG. 9A illustrates an example of an optical system having a lens assembly 910 in which mutliple lenses are disposed in a juxtaposed layered arrangement. The lenses include a transparent material. To achieve at least one non-uniform optical property within the lens assembly 910, various methods may be employed as described above. The lens assembly 910 may be deformable or flexible before implantation. After implantation, lens assembly 910 is held in position by eye muscles 926 and the shape of the lens assembly 910 is generally fixed or may be made variable by selecting a suitable material for fabrication of the lenses. The lens assembly 910 is suitably disposed so that focused images are formed on a first focal plane 930, i.e. an optic nerve or retina of an eye, which is maintained at a fixed distance from the lens assembly. The first focal plane 930 may or may not be a flat surface.

FIG. 9B illustrates an example of an optical system having a lens assembly 910 formed of seven lenses being supported by a retainer structure 920. The lenses include a transparent material and the retainer structure may or may not be transparent.

FIG. 9C illustrates an example of an optical system having a lens assembly 910 formed of two lenses being supported by a retainer structure 920. The lenses include a transparent material and the retainer structure may or may not be transparent.

In the above embodiments as illustrated in FIGS. 1A-1B, 2-6, 8A-8B, 9A-9C, and other embodiments not explicitly described, the lens assembly may be operable to convert infra red rays, having a wavelength within an invisible spectrum, into light rays, having a wavelength within a visible spectrum, to form an image with enhanced quality. More particularly, the formed image is formed using both light rays and converted light rays, i.e. converted from infra red rays, from the object.

For the sake of clarity in the illustrations, the lens assembly has been illustrated as having well-defined boundaries between adjacent lenses or substrate layers or graded layers. It is to be appreciated that the boundaries between adjacent lenses or substrate layers may be less clearly defined. In particular, the variation of the optical properties between lenses may occur in a gradual manner.

Further, a graded lens may have a same optical effect as a composite lens being formed of multiple lenses having at least one different optical property. Theoretically, each of the multiple lenses may have a minute thickness, e.g. having a thickness of an atomic layer, and therefore a graded lens may be construed as being formed of a very large number or near-infinite number of lenses with minute thickness.

Embodiments of the invention may be employed in a variety of optical applications including, but not limited to a barcode reader, a digital camera, an analogue camera, mobile phone camera, camera using photographic film, and an eye implant. Such digital and analogue cameras may be used in devices and applications, including but not limited to, automotive cameras, security cameras, remote control cameras, remote control devices, mobile device cameras, endoscopic capsule cameras, endoscope camera, cameras used in medical applications, cameras used in telescopes, cameras used in space applications.

A method of fabricating an optical system as described in the above embodiments is described as follows. A retainer structure and a first lens may be separately molded, such as by two-colour molding or by in-mold decoration. Either the retainer structure or the intermediate lens may or may not be molded first. Subsequently, a lens assembly having a non-uniform optical property may be formed by disposing the first lens and a second lens in the retainer structure in a juxtaposed arrangement. Materials for the lenses are suitably selected so that at least one of the first and the second lens has a graded optical property. Further, but optionally, at least one of the first and the second lens may be a non-graded lens. The above-described method is exemplary, and it is to be understood that other methods of fabrication may be used with suitable modifications.

Other embodiments will be apparent to those skilled in the art from consideration of the specification and practice of the invention. Furthermore, certain terminology has been used for the purposes of descriptive clarity, and not to limit the embodiments as disclosed. The embodiments and features described above should be considered exemplary, with the invention being defined by the appended claims.

What is claimed is:

1. An optical system comprising:
a lens assembly including a plurality of lenses disposed in a juxtaposed arrangement, the lens assembly having at least one non-uniform optical property, wherein the lens assembly is operable to simultaneously focus a plurality of light rays originating from a plurality of distances onto a first focal plane which is maintained at a fixed distance from the lens assembly.

2. The system of claim 1, wherein at least one of the plurality of lenses has at least one graded optical property.

3. The system of claim 2, wherein the at least one of the plurality lenses having at least one graded optical property has a same optical effect as a composite lens formed of another plurality of lenses having at least one different optical property.

4. The system of claim 1, wherein at least two of the plurality of lenses have at least one different optical property, and the at least two of the plurality of lenses are non-graded lenses.

5. The system of claim 1, wherein at least two of the plurality of lenses are disposed in different directions.

6. The system of claim 1, further comprising: a retainer structure for supporting the lens assembly.

7. The system of claim 6, wherein the retainer structure and one of the lenses are integrally formed.

8. The system of claim 6, wherein the retainer structure includes a transparent material.

9. The system of claim 8, wherein at least a portion of the retainer structure is rendered opaque.

10. The system of claim 6, wherein the retainer structure includes a heat-resistant material.

11. The system of claim 10, wherein the heat resistant material includes a high temperature resistant liquid crystal plastic.

12. The system of claim 11, wherein the liquid crystal plastic includes one of a plurality of glass frits and a plurality of glass fibers.

13. The system of claim 6, wherein the lens assembly is employed in a reflow oven.

14. The system of claim 1 further comprising: an actuator coupled to one of the plurality of lenses for varying at least one of a physical property and an optical property thereof to perform at least one of a zoom function and a focus function.

15. The system of claim 14, wherein at least one of the lenses is one of non-deformable and deformable as a result of the varying at least one of a physical property and an optical property.

16. The system of claim 14, wherein at least one of the plurality of lenses is non-deformable when operable by the actuator, and the at least one of the plurality of lenses is one of non-compressible and compressible.

17. The system of claim 14, wherein at least one of the plurality of lenses is deformable when operable by the actuator, and the at least one of the plurality of lenses is one of non-compressible and compressible.

18. The system of claim 14, wherein the physical property is one of mass, shape, volume, density, thermal property, magnetic property, hardness, energy conversion factor, length, width and radius of curvature.

19. The system of claim 14, wherein the actuator includes a plurality of piezo materials mounted on a plurality of opposed surfaces of an actuating substrate, the piezo materials and the actuating substrate having an opening therethrough for disposing the lens assembly therein, the actuator is for applying one of a compressive and a decompressive force on the actuating substrate.

20. The system of claim 14, wherein the actuator includes a control circuit for applying a voltage to a piezo material which is coupled to the actuating substrate, the control circuit being configured to produce an alternating-polarity variable output in response to a fixed-polarity variable input.

21. The system of claim 1, wherein at least one of the plurality of lenses includes a plurality of defects, the lens assembly being operable to increase a contrast of an image formed between the defects to perform an automatic-focusing function.

22. The system of claim 1, wherein the lens assembly is operable to convert an infra red ray into a converted light ray, having a wavelength within a visible spectrum, to focus the converted light ray onto the first focal plane.

23. The system of claim 1, wherein at least one of the plurality of lenses includes one of a glass, an epoxy, a polymer, a monomer, a plastic, an optical material, and an optically active material.

24. The system of claim 1, wherein the optical property is one of refractive index, light transmission coefficient, absorption coefficient, dispersion power, polarization, stretchability, Abbe number, focal length, optical power, reflective performance, refractive performance, spot size, resolution, modulation transfer function (MTF), distortion, and diffractive performance.

25. The system of claim 1, wherein the lens assembly is disposed in one of a barcode reader, a digital camera, an analogue camera and an infra red camera.

26. The system of claim 1, wherein the system is disposed in one of an eye implant and prescription glasses.

27. The system of claim 1, wherein at least one of the plurality of lenses is in solid state.

28. The system of claim 1, wherein the plurality of lenses are in solid state.

29. The system of claim 1, wherein at least one of the plurality of lenses is one of a soft form, a soft state, a gaseous state, a flowable state and a flowable form.

30. The system of claim 1, wherein a separation distance between a second focal plane where an image of a near object is formed and a third focal plane where an image of a far object is formed has a tolerance limit of at least about ±300 micrometres.

31. The system of claim 1, wherein a separation distance between a second focal plane where an image of a near object is formed and a third focal plane where an image of a far object is formed has a tolerance limit of at most about ±300 micrometres.

32. An optical system comprising:
a lens assembly including a plurality of lenses disposed in a juxtaposed arrangement, at least one of the lenses having a graded optical property, wherein the lens assembly is operable to simultaneously focus a plurality of light rays originating from a plurality of distances onto a first focal plane which is maintained at a fixed distance from the lens assembly.

33. A method of fabricating an optical system, comprising:
separately molding a retainer structure and a first lens; and
forming a lens assembly having a non-uniform optical property, including disposing the first lens and a second lens in the retainer structure in a juxtaposed arrangement.

34. The method of claim 33, wherein forming a lens assembly having a non-uniform optical property further includes disposing at least one of the first and the second lens which has a graded optical property to achieve the non-uniform optical property.

35. The method of claim 33, wherein forming a lens assembly having a non-uniform optical property further includes disposing the first and the second lens which has at least one different optical property to achieve the non-uniform optical property.
